(19) United States
(12) Patent Application Publication
(10) Pub. No.: US 2006/0208230 A1
(43) Pub. Date: Sep. 21, 2006

(54) Method for manufacturing printed circuit board using Ag-Pd alloy nanoparticles

(76) Inventors: Hye-Jin Cho, Suwon-si (KR); Byung-Ho Jun, Seoul (KR)

Correspondence Address: STANZIONE & KIM, LLP, 919 18TH STREET, N.W., SUITE 440, WASHINGTON, DC, 20006, US

(21) Appl. No.: 11/371,101

(22) Filed: Mar. 9, 2006

(30) Foreign Application Priority Data
Mar. 18, 2005 (KR) 2005-22606

(51) Int. Cl. H01B 1/12

(52) U.S. Cl. 252/500

(57) ABSTRACT

The PCB manufactured by spraying conductive ink dispersed with Ag—Pd alloy nanoparticles and curing to form wiring according to the present invention provides reduced migration of Ag ions. Further, the present invention provides a method for manufacturing PCB which exhibits competitive price, and excellent conductivity and anti-migration. As one aspect of the present invention, a conductive ink comprising Ag—Pd alloy nanoparticles, wherein the Ag—Pd alloy nanoparticles includes Pd in the range of from 5 weight % to 40 weight %.

### CROSS-REFERENCE TO RELATED APPLICATIONS

This application claims the benefit of Korean Patent Application No. 2005-0022606, filed on Mar. 18, 2005, with the Korea Intellectual Property Office, herein incorporated by reference in its entirety.

### BACKGROUND OF THE INVENTION

1. Field of the Invention

The present invention relates to a method for manufacturing a printed circuit board (PCB) by forming a circuit pattern with conductive inks by inkjet printing method.

2. Description of the Related Art

The metal wiring technology of the printed circuit board (PCB) has been developed in order of etching, screen printing and ink-jet printing technology. Among these, the screen printing technology, which comprises performing screen printing using metal paste and curing, has been known and still widely used. However, it has some drawbacks: i) the curing temperature is too high; and ii) it requires excess use of anhydrous solvent which is very expensive and risky so that it is not possible to use easy and convenient metal wiring on the PCB. Further, writing method by the screen printing method is applied to the field where width of formed circuit pattern is not very narrow so that metal power having an average diameter of 0.5 to 20 microns is used as a conductive ink by dispersing into a thermoset resin composition.

On the other hand, there is recently relentless trend toward miniaturization in information appliances so that wiring spacing of the PCB mounted thereon becomes narrower and also trend toward precision and accuracy of circuits so that line width and layer thickness of circuit patterns formed on the PCB become narrower and thinner. In case that layer thickness is several microns, when conventional metal paste which includes metal component having an average diameter of more than 0.5 micron is used, distribution of layer thickness becomes relatively large and conductivity becomes irregular. Moreover, it may deteriorate conductivity because of loose contact between particles.

Since the ink-jet method is a direct-writing method by using liquid metal inks including fine metal powder, it can narrower minimum line width and minimum wire spacing so that it allows high density circuit patterns.

In the ink-jet method, conductive wiring board is prepared by directly forming conductive circuits by spraying a conductive ink, in which metal particles such as Ag or Cu is dispersed into an organic solvent, on a substrate using an ink-jet apparatus and then performing a curing process. Because patterning of the ink-jet method uses a fine nozzle, it is important that metal nanoparticles in the ink maintain uniform dispersion concentration. Example of the metal particle includes Au, Ag, Cu and so on but Cu among them is widely used in present with advantages in cost and anti-ion migration property. However, it is very susceptible to oxidation with increases of the surface area of Cu as particle size is getting smaller closer to nano-size and as a result, it forms a silicon dioxide film on the surface by reacting with oxygen in air. Particularly, the oxidation reaction is promoted by air containing moisture. It is difficult to completely avoid the oxidation on the surface although various methods have been tried to prevent the Cu oxidation.

On the other hand, when PCB is manufactured by patterning fine circuits with ultra fine print ink prepared using Au or Ag nanoparticles, and performing a curing process, it allows wiring having a volume specific resistivity of less than 1×10-5Ω at wiring line width/wiring spacing (L/S) of about 5 to 50 microns. However, Au is very costly so that it causes increase of the manufacturing unit cost. On the other hand, when Ag nanoparticles are used, it offers reduced manufacturing cost and good conductivity. But the PCB exposed to high moisture of high temperature leads to dendrite growth toward (−) electrode(cathode) which Ag ions plate out, with narrowing wiring line width/wiring spacing. As a result, it causes disconnection or short between circuits or wirings, and may further damage products. When high humidity or high temperature condition is eliminated after the migration happened, the migrated state is remained, so that it makes difficult to have confidence of the product.

Therefore, it is highly demanded to obtain a method for manufacturing PCBs with conductive inks which include conductive metal nanoparticles and provide anti-ion migration.

### SUMMARY OF THE INVENTION

As a solution to overcome the defects associated with conventional technologies, an object of the present invention provides a conductive ink comprising Ag—Pd alloy nanoparticles.

Also, the present invention provides a method for manufacturing printed circuit board (PCB), having wiring which exhibits competitive price and excellent, conductivity and anti-migration.

Also, the present invention provides a PCB having wiring formed into fine circuit pattern, which may exhibit competitive price and excellent conductivity and anti-migration, and may not cause disconnection or shorts due to the metal ion migration even at a desired wiring width and spacing.

### BRIEF DESCRIPTION OF THE DRAWINGS

FIG. 1 is a schematic diagram illustrating a mechanism of the ion migration.

FIG. 2 is a photograph of a branching structure of dendrite generated by the ion migration into the circuit of a substrate.

FIG. 3 is a cross-sectional view of dendrite generated in the circuit of a substrate.

FIG. 4 is a diagram of insulation resistance declining with time due to the ion migration.

FIG. 5 is a graph illustrating insulation resistance values when after a conductive ink including Ag nanoparticles is sprayed with L/S 100 microns on a substrate and cured to form wiring, 2.5V voltage for 60 seconds is permitted under the condition of humidity 85% and temperature 85° C., according to the present invention.

FIG. 6 is a graph illustrating insulation resistance values when after conductive ink including Ag—Pd alloy nanoparticles is sprayed with L/S 100 microns on a substrate and cured to form wiring, 2.5V voltage for 60 seconds is permitted under the condition of humidity 85% and temperature 85° C., according to the present invention.

### DETAILED DESCRIPTION OF THE PREFERRED EMBODIMENTS

When a PCB is manufactured using a conductive ink including a mixture of Ag and Pd nanoparticles, not Ag—Pd alloy nanoparticles, it causes some drawbacks: i) it is difficult to disperse the mixture powder uniformly in an ink solvent; ii) a circuit obtained by coating on a substrate and curing has spots formed during a curing process; and iii) there is a limit to completely preventing the ion migration. Therefore, the present invention tries to solve the above-mentioned problems by using a conductive ink which is Ag—Pd alloy nanoparticles dispersed in an organic solvent.

A conductive ink according to a preferable embodiment of the present invention comprises Ag—Pd alloy nanoparticles wherein the Ag—Pd alloy nanoparticles includes Pd in the range of from 5 weight % to 40 weight %, more preferably in the range of from 10 weight % to 30 weight %. The conductive ink may be used as wiring materials of PCBs.

The Ag—Pd alloy nanoparticles included in the conductive ink according to a preferred embodiment of the present invention may be a nano-size having a diameter of 1 to 50 nm, which can pass through an ink-jet nozzle.

The conductive ink according to a preferred embodiment of the present invention is manufactured by dissolving palladium acetate and silver acetate (Ag acetate) in sodium dodecyl sulfate (SDS) aqueous solution and reacting by heat the solution. In this case, the conductive ink is simply manufactured without mixing of any organic solvent. The reacting by heat may be preferably performed at 130° C. in an oil bath.

The present invention provides a method for manufacturing a PCB and PCB manufactured thereby, which comprises the step of manufacturing a conductive ink by dispersing Ag—Pd alloy nanoparticles in an organic solvent; and forming wiring by spraying the conductive ink on a substrate using an ink-jet method and curing the substrate. The Ag—Pd alloy nanoparticles includes Pd in the range of from 5 weight % to 40 weight %, preferably in the range of from 10 weight % to 30 weight %.

The Ag—Pd alloy nanoparticles may be a nano-size, which can get through an ink-jet nozzle, preferably having a diameter of from 1 to 50 nm.

In case that the Pd in Ag—Pd alloy nanoparticles is 5 weight % or less, it is not enough to prevent the migration of Ag⁺ ions. On the other hands in case that the Pd in Ag—Pd alloy nanoparticles is 40 weight % or higher, the wiring conductivity is declined, and a profitability decreases due to increased amount of expensive Pd.

The conductive ink of the present invention is more demanded particularly for PCBs with a fine circuit pattern which have narrow wiring width and wiring spacing and further cause the ion migration. The wiring width and wiring spacing, which may cause disconnection or short by the ion migration as mentioned above, is generally 100 microns or under. Therefore, the conductive ink of the present invention is very useful in PCBs which have the wiring width and wiring spacing (L/S) of 100 microns or under.

The organic solvent of the present invention for dispersing nanoparticles can be any organic solvent used for a conductive ink.

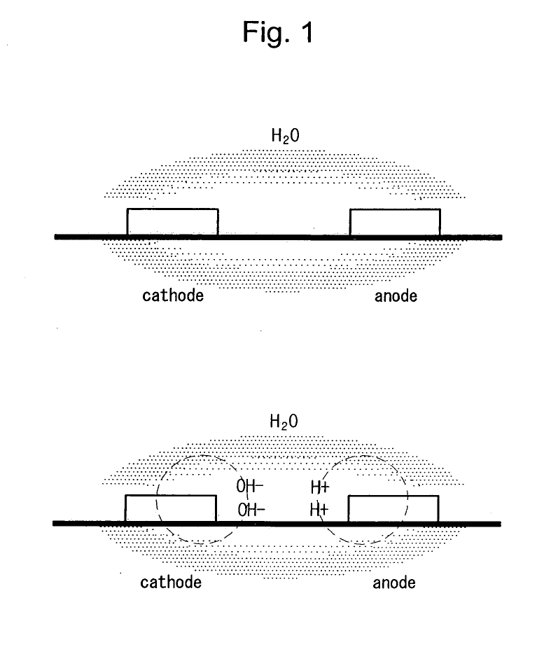

Ion migration is that metal ions ionized on adjacent electrode to a PCB and the like migrate to another electrode where they get reduced and deposit as a metal. FIG. 1 shows a mechanism of the ion migration.

A reaction at a cathode is:
Ag+OH⁻→AgOH+e⁻ (1)
2AgOH→Ag₂O+H₂O (2)
Ag₂O+H₂ [symbol] 2Ag⁺+2OH (3)

A reaction at an anode is:
Ag++e-→Ag (4)

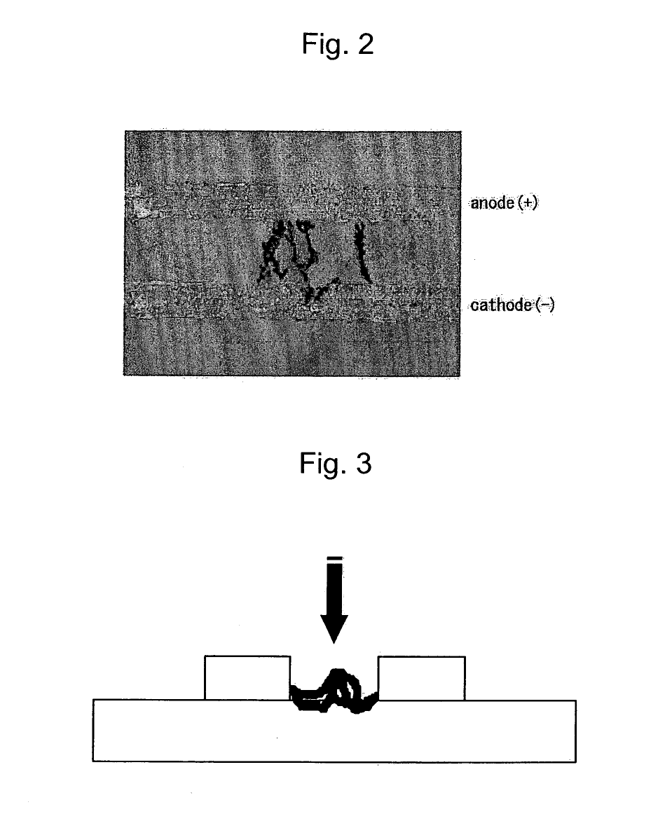

As described above, silver ions generated in the cathode move to the anode, bond with electrons, and finally deposit as silver metals which result in growth of branching structure of dendrite toward the cathode. FIG. 2 is a photograph illustrating short between the cathode and the anode due to the branching structure of dendrite growth by the ion migration toward the cathode. FIG. 3 shows a cross-sectional view of the generated dendrite.

The migration of ions comes from the contact with moisture between electrodes which actually often occurs a buildup of the metal at the anode of the substrate. Such ion migration is a growing problem because of recent trend toward miniaturization of wiring within IC packages such as build-up board, BGA and the like which results in increase of electric field strength between patterns and shortened insulation distance and easy absorption of moisture with portable electronic equipments.

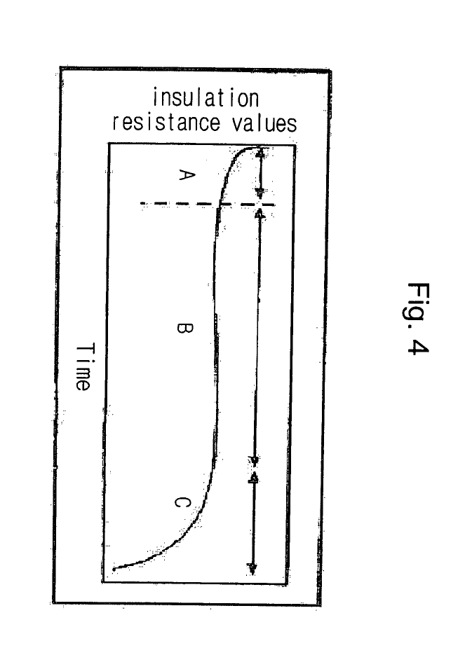

Measurement of ion migration is achieved by detecting decline of insulation resistance. If the ion migration is generated as time goes by, the insulation resistance decreases as shown in FIG. 4.

According to FIG. 4, in the initial step (A), insulation resistance is decreased by absorption of moisture or insulating material, and in the intermediate step (B), the resistance becomes stabilized. In the final step (C), the resistance is rapidly decreased when the ion migration starts so that this point where the resistance drops rapidly can be regarded as the point where the ion migration starts.

### EMBODIMENTS

Hereinafter, the present invention will be described in more detail by way of the following embodiments, which are not intended to limit the scope of the present invention.

### Comparative Example 1

### Preparation of Ag Nanopraticle-Dispersed Conductive Ink

Silver acetate precursor was dissolved in 50 Ml of 0.1M sodium dodecyl sulfate (SDS) aqueous solution to have a concentration of 4.5×10⁻⁴ mol. The solution was heated slowly in an oil bath and reacted at 130° C. for 9 hours to obtain Ag ink dispersed with Ag nanoparticle size of 1 to 50 nm.

### Examples 1 to 5

### Preparation of Ag—Pd Alloy Nanopraticle Dispersed Conductive Ink

2 Kinds precursors of Palladium acetate and silver acetate precursor were dissolved in 50 Ml of 0.1M sodium dodecyl sulfate (SDS) aqueous solution to have a concentration of 4.5×10⁻⁴ mol. The solution was heated slowly in an oil bath and reacted at 130° C. for 9 hours to obtain an ink dispersed with Ag—Pd alloy nanoparticle size of 1 to 50 nm. Inks with various Pd weight % based on the Ag—Pd alloy were prepared: 5 weight % (example 1); 10 weight % (example 2); 20 weight % (example 3); 30 weight % (example 4); and 40 weight % (example 5),

### Comparative Example 2

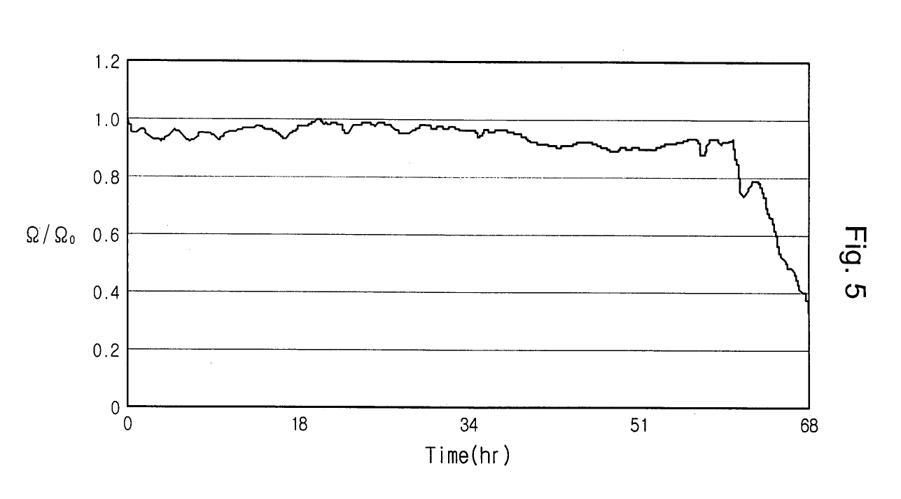

The conductive ink including Ag nanoparticles manufactured in comparative example 1 was sprayed with L/S 100 microns on a substrate using an ink-jet printer, and cured at 250° C. to form wiring. 2.5V voltage for 60 seconds to the substrate was applied under the condition of humidity 85%, temperature 85° C. Changes in insulation resistance was observed. The result was illustrated in FIG. 5. The insulation resistance from an initial stage to 60 hours was maintained at the initial insulation resistance. But as soon as passing 60 hours, the resistance was rapidly decreased by occurrence of the ion migration.

### Examples 6 to 10

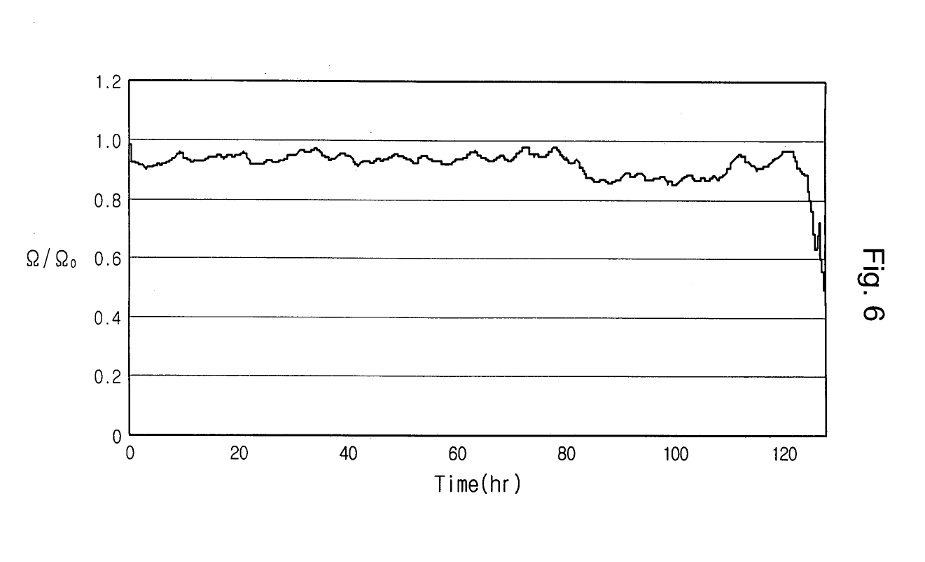

The conductive ink including Ag—Pd alloy nanoparticles manufactured in examples 1 to 5 was sprayed with L/S 100 microns on a substrate using an ink-jet printer and cured at 250° C. to form wiring. The conductivity of the substrate was measured. 2.5V voltage for 60 seconds to the substrate was applied under the condition of humidity 85%, temperature 85° C. Changes in insulation resistance was observed and the time maintaining the initial insulation resistance (the time forming dendrite) without any changes was detected which was summarized in Table 1 with the result of Comparative example 2. When Pd weight % in the Ag—Pd alloy is 30 weight %, the change in the insulation resistance was illustrated in FIG. 6.

TABLE 1

| | Composition | | |
|---|---|---|---|
| | (Ag weight %/ | Conductivity | Time for Dendrite |
| Category | Pd weight %) | (μΩ · cm) | formation(hr) |
| Comparative | Ag 100 | 3.23 | 60 |
| example. 2 | | | |
| Example 6 | 95/5 | 5.85 | 60 |
| Example 7 | 90/10 | 9.01 | 82.5 |
| Example 8 | 80/20 | 15.89 | 95 |
| Example 9 | 70/30 | 25.74 | 120 |
| Example 10 | 60/40 | 48.3 | — |

Referring to Table 1, when amount of Pd was 5 weight % or less, it was not enough to prevent the migration of Ag⁺ ions While when amount of Pd was 40 weight % or higher, there was no ion migration, but the conductivity was noticeably declined. In addition, it was noted that when amount of Pd was 30 weight % in the Ag/Pd alloy total weight it showed the most stable conductivity and the ion migration was occurred after 120 hours as shown in Table 2 and FIG. 6. It is noted that when 30 weight % of Pd was used, anti-migration is improved twice compared to that when only Ag Nanoparticles was used.

### INDUSTRIAL AVAILABILITY

The PCB manufactured by spraying conductive ink dispersed with Ag—Pd alloy nanoparticles and curing to form wiring according to the present invention provides reduced migration of Ag ions. Further, the present invention provides a method for manufacturing PCB which exhibits competitive price, and excellent conductivity and anti-migration.

What is claimed is:

1. A conductive ink comprising Ag—Pd alloy nanoparticles, wherein the Ag—Pd alloy nanoparticles includes Pd in the range of from 5 weight % to 40 weight %.

2. The conductive ink of claim 1, wherein the Ag—Pd alloy includes Pd in the range of from 10 to 30 weight %.

3. The conductive ink of claim 1, wherein the Ag—Pd alloy nanoparticles has a diameter of 1 to 50 nm.

4. The conductive ink of claim 1, wherein the conductive ink is manufactured by dissolving palladium acetate and silver acetate (Ag acetate) in sodium dodecyl sulfate (SDS) aqueous solution and reacting by heat the solution.

5. The conductive ink of claim 4, wherein the conductive ink is manufactured by dissolving palladium acetate and silver acetate (Ag acetate) in sodium dodecyl sulfate (SDS) aqueous solution and the reacting by heat the solution at 130° C. in an oil bath for 9 hours.

6. A method for manufacturing a printed circuit board, comprising:
manufacturing the conductive ink comprising Ag—Pd alloy nanoparticles including Pd in a range of from 5 weight % to 40 weight %; and
forming wiring by spraying the conductive ink on a substrate and curing the substrate.

7. The method of claim 6, wherein the Ag—Pd alloy nanoparticles has a diameter of 1 to 50 nm.

8. The method of claim 6, wherein the step of manufacturing the conductive ink comprising the step of:
dissolving palladium acetate and silver acetate (Ag acetate) in sodium dodecyl sulfate (SDS) aqueous solution; and
reacting by heat the solution.

9. The method of claim 6, wherein the step of manufacturing the conductive ink comprising the step of:
dissolving palladium acetate and silver acetate (Ag acetate) in sodium dodecyl sulfate (SDS) aqueous solution; and
reacting by heat the solution at 130° C. in an oil bath for 9 hours.

10. The method of claim 6, wherein the step of forming wiring comprises forming a pattern on the substrate by an ink-jet printing method.

11. A printed circuit board manufactured by a method comprising:
manufacturing the conductive ink comprising Ag—Pd alloy nanoparticles including Pd in a range of from 5 weight % to 40 weight %; and
forming wiring by spraying the conductive ink on a substrate and curing the substrate.

12. The printed circuit board of claim 11, wherein the wiring formed on printed circuit board has wiring width and wiring spacing where short may be occurred by the ion migration.
